(19) United States
(12) Patent Application Publication
(10) Pub. No.: US 2023/0319595 A1
(43) Pub. Date: Oct. 5, 2023

(54) SLAVE STATION SYSTEM

(71) Applicant: NIPPON TELEGRAPH AND TELEPHONE CORPORATION, Tokyo (JP)

(72) Inventors: Hirofumi YAMAMOTO, Musashino-shi, Tokyo (JP); Keita TAKAHASHI, Musashino-shi, Tokyo (JP); Hiroko NOMURA, Musashino-shi, Tokyo (JP)

(73) Assignee: NIPPON TELEGRAPH AND TELEPHONE CORPORATION, Tokyo (JP)

(21) Appl. No.: 18/022,637

(22) PCT Filed: Aug. 27, 2020
(86) PCT No.: PCT/JP2020/032475

§ 371 Date: Feb. 22, 2023

(51) Int. Cl. H04W 24/02

(52) U.S. Cl. CPC H04W 24/02; H04W 92/04

(57) ABSTRACT

A slave station system 2 includes: a first shared slave station device 10 connected to a plurality of master station devices including at least a first master station device 3a and a second master station device 3b different from the first master station device 3a, and a second shared slave station device 20 connected to the first shared slave station device 10. The first shared slave station device 10 is equipped with a first individual function unit 11a corresponding to the first master station device 3a and a second individual function unit 11b corresponding to the second master station device 3b. The second shared slave station device 20 is equipped with a common function unit 21 connected to the first individual function unit 11a and the second individual function unit 11b and functioning regardless of the types of the plurality of master station devices.

### TECHNICAL FIELD

The present disclosure relates to a slave station system.

### BACKGROUND ART

A technique related to a communication system including a base station device is disclosed in NPL 1. A conventional base station device such as the one disclosed in NPL 1 includes a master station device and at least one slave station device connected to the master station device.

### CITATION LIST

### Non Patent Literature

[NPL 1] O-RAN Fronthaul Specification Outline, NTT DOCOMO Technical Journal Vol. 27, No. 1 (April 2019)

### SUMMARY OF INVENTION

### Technical Problem

In the prior art such as the NPL described above, for example, individual slave station devices corresponding to the master station devices of the respective communication carriers are required. For this reason, a wide space is required for installing all the slave station devices. In addition, since locations for installing the slave station devices are actually limited, it is considered that a plurality of slave station devices corresponding to the master station devices of the respective communication carriers are collectively installed at the same base. In this case, there arises a problem that the equipment configuration becomes complicated at the installation site of the slave station devices.

The present disclosure has been made in order to solve the foregoing problems. An object of the present disclosure is to obtain a slave station system capable of improving the efficiency of an installation area and simplifying an equipment configuration.

### Solution to Problem

A slave station system according to the present disclosure includes: a first shared slave station device that is connected to a plurality of master station devices including at least a first master station device and a second master station device different from the first master station device; and a second shared slave station device that is connected to the first shared slave station device. The first shared slave station device is equipped with a first individual function unit corresponding to the first master station device and a second individual function unit corresponding to the second master station device. The second shared slave station device is equipped with a common function unit connected to the first individual function unit and the second individual function unit and functioning regardless of the types of the plurality of master station devices.

### Advantageous Effects of Invention

According to the present disclosure, a slave station system capable of improving the efficiency of an installation area and simplifying an equipment configuration can be obtained.

### BRIEF DESCRIPTION OF DRAWINGS

FIG. 1 is a diagram schematically showing an entire configuration of a communication system according to Embodiment 1.

FIG. 2 is a diagram showing a communication system according to a comparative example.

FIG. 3 is a diagram showing a modification of the communication system according to Embodiment 1.

FIG. 4 is a diagram schematically showing an entire configuration of a communication system according to Embodiment 2.

FIG. 5 is a diagram showing a modification of the communication system according to Embodiment 2.

### DESCRIPTION OF EMBODIMENTS

Embodiments will be described with reference to the drawings. The same reference numerals in each diagram denote the same or corresponding parts. In the present disclosure, repeated descriptions will be appropriately simplified or omitted. Note that the present disclosure is not limited to the following embodiments. The present disclosure may include various modifications and combinations of configurations disclosed in the following embodiments without departing from the spirit of the present disclosure.

### Embodiment 1.

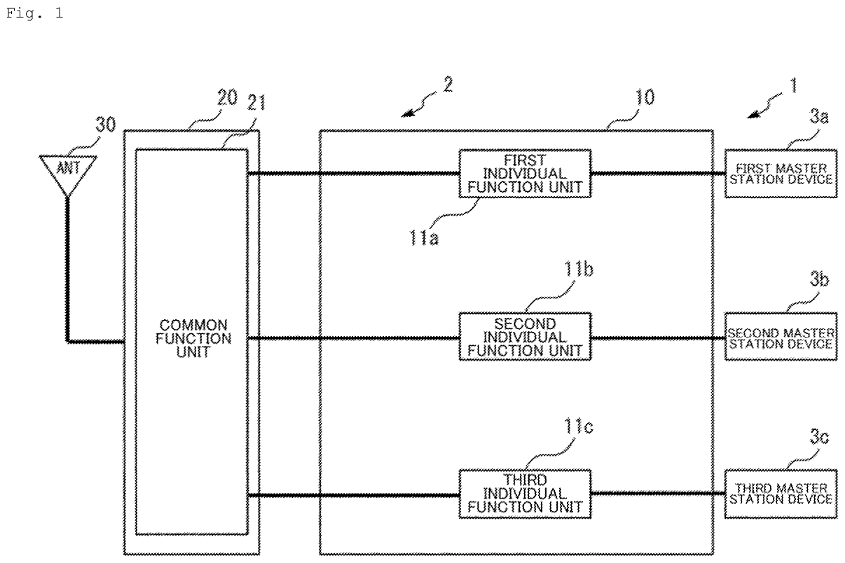

FIG. 1 is a diagram schematically showing an entire configuration of a communication system 1 according to Embodiment 1. The communication system 1 includes a plurality of master station devices and a slave station system 2 connected to the plurality of master station devices. The plurality of master station devices include at least a first master station device 3a and a second master station device 3b different from the first master station device 3a. The number of the plurality of master station devices to which the slave station system 2 is connected may be three or more. In the illustrated example, the plurality of master station devices to which the slave station system 2 is connected include a third master station device 3c different from the first master station device 3a and the second master station device 3b.

For example, when the communication system 1 is applied to a mobile base station that provides wireless communication, each master station device is equipped with functions of a CU (Centralized Unit) and a DU (Distributed UNIT) of each MNO (Mobile Network Operator). When the communication system 1 is applied to a mobile base station, the slave station system 2 is equipped with a function of a RU (Radio Unit). The CU and the DU constituting the mobile base station perform digital signal processing, and the RU converts a digital signal into a radio signal. The radio signal is radiated by an antenna in a predetermined target direction.

The slave station system 2 according to the present embodiment can be applied not only to a mobile base station that provides wireless communication, but also to various communication systems 1. The slave station system 2 can be applied to a wireless communication system utilizing, for example, 5G, local 5G, LTE, and various wireless LANs, and to a wired communication system. The slave station system 2 can be applied to any communication system 1 composed of a master station device and a slave station device.

The slave station system 2 is installed away from each master station device. The slave station system 2 according to the present embodiment includes a master station side shared slave station 10 which is an example of the first shared slave station device, and a slave station side shared slave station 20 which is an example of the second shared slave station device.

The master station side shared slave station 10 is connected to a plurality of master station devices. In the illustrated example, the master station side shared slave station 10 is connected to the first master station device 3a, the second master station device 3b, and the third master station device 3c. The master station side shared slave station 10 communicates with each master station device.

The master station side shared slave station 10 and the plurality of master station devices are physically connected by physical media such as single-core optical fibers or multi-core fibers in the same number as the number of the master station devices. The master station side shared slave station 10 and the plurality of master station devices may be connected via a transmission device such as a WDM device provided between the master station side shared slave station 10 and the plurality of master station devices. The master station side shared slave station 10 and the plurality of master station devices may be physically connected by one physical medium such as a single-core optical fiber. Further, the master station side shared slave station 10 and the plurality of master station devices may be logically disconnected by, for example, a VLAN or the like.

At least a first individual function unit 11a corresponding to the first master station device 3a and a second individual function unit 11b corresponding to the second master station device 3b are mounted on the master station side shared slave station 10. In the illustrated example, a third individual function unit 11c corresponding to the third master station device 3c is also mounted on the master station side shared slave station 10. The master station side shared slave station 10 is equipped with the same number of individual function units as the number of master station devices to which the slave station system 2 is connected. In the illustrated example, the master station side shared slave station 10 is equipped with a total of three individual function units, i.e., the first individual function unit 11a, the second individual function unit 11b, and the third individual function unit 11c. The number of master station devices to which the slave station system 2 is connected may be any number of two or more. The number of individual function units mounted on the master station side shared slave station 10 may be any number of two or more. The plurality of individual function units are housed in the same housing, for example.

The individual function units according to the present disclosure each have a function that requires individual management, setting, control, and the like for each master station device, out of the functions of the conventional slave station devices. When the slave station system 2 is applied to a mobile base station, the individual function units each have a function requiring individual management, setting, control, and the like for each MNO, out of functions of a conventional RU.

For example, the individual function units are configured to be operable independently of each other. In the present embodiment, for example, even if an abnormality occurs in the first master station device 3a or the first individual function unit 11a, the abnormality does not impact the second individual function unit 11b and the third individual function unit 11c. Even if an abnormality occurs in connection and communication between the first master station device 3a and the first individual function unit 11a, the abnormality does not impact the second individual function unit 11b and the third individual function unit 11c.

The slave station side shared slave station 20 is connected to the master station side shared slave station 10 equipped with the individual function units. The slave station side shared slave station 20 communicates with the master station side shared slave station 10. The slave station side shared slave station 20 is provided outside the master station side shared slave station 10. For example, the slave station side shared slave station 20 is installed at a place away from the master station side shared slave station 10.

The slave station side shared slave station 20 and the master station side shared slave station 10 are connected by physical media such as single-core optical fibers or multi-core fibers in the same number as the number of individual function units mounted on the master station side shared slave station 10, for example. Further, the slave station side shared slave station 20 and the master station side shared slave station 10 may be logically disconnected by, for example, a VLAN or the like.

The slave station side shared slave station 20 is equipped with a common function unit 21 functioning regardless of the types of the master station devices. The common function unit 21 has a common function which does not depend on individual setting or the like of each master station device, out of the functions of the conventional slave station devices. The common function unit 21 is housed in a housing different from the housing in which the individual function units are housed. The common function unit 21 is connected to the first individual function unit 11a and the second individual function unit 11b. As shown in the diagrams, the common function unit 21 may be connected to the third individual function unit 11c. In the illustrated example, the common function unit 21 communicates with the first individual function unit 11a, the second individual function unit 11b, and the third individual function unit 11c.

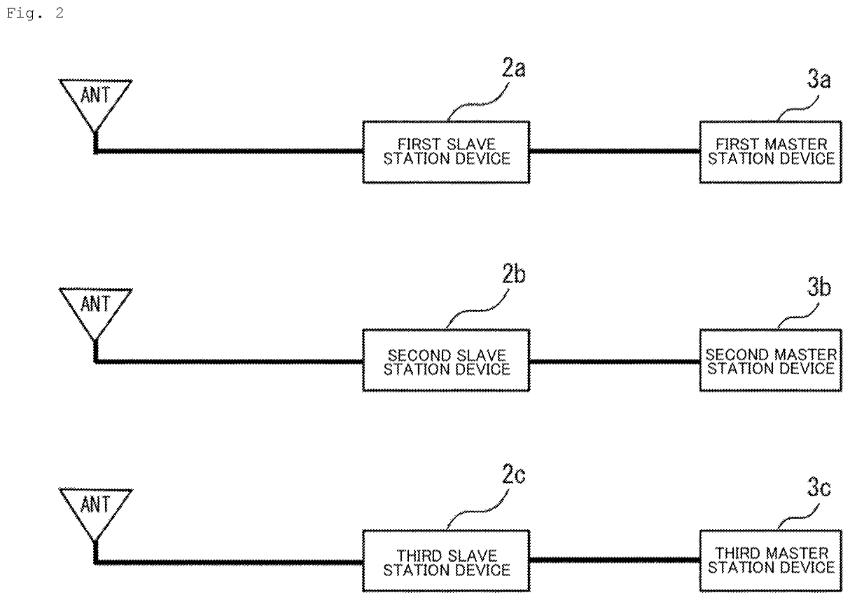

FIG. 2 is a diagram showing a communication system according to a comparative example. The comparative example in FIG. 2 schematically shows a conventional mobile base station. The conventional mobile base station shown in FIG. 2 is provided with a first slave station device 2a, a second slave station device 2b, and a third slave station device 2c. In the comparative example shown in FIG. 2, individual antennas are connected to each of the slave station devices. The first slave station device 2a, the second slave station device 2b, and the third slave station device 3c each have a common function independent of a master station. The first slave station device 2a, the second slave station device 2b, and the third slave station device 2c have, as the common functions independent of the master station, for example, an antenna control function (e.g., a tilt angle control function), a power amplifier function, a function of a power supply unit for antenna control, and various other functions. The common function unit 21 according to the present embodiment has a function that is commonly held by the conventional slave station devices described above.

A specific example of functions of the individual function units mounted on the master station side shared slave station 10 and the common function unit 21 mounted on the slave station side shared slave station 20 when the slave station system 2 is applied to the mobile base station will now be described. The functions of the individual function units and the common function unit 21 according to the present disclosure are not limited to the following examples.

For example, the slave station system 2 acquires reference definition information from each master station device in order to exchange hardware management information for managing hardware, such as an antenna, with each master station device. Also in the conventional example shown in FIG. 2, each slave station device acquires reference definition information from the master station. In the conventional example shown in FIG. 2, the reference definition information includes common reference definition information independent of the types of the master station devices. For example, the common function unit 21 has a function of acquiring the common reference definition information shown in the conventional example in FIG. 2. The common function unit 21 has a function of operating on the basis of the acquired common reference definition information, such as, for example, a function of controlling hardware such as an antenna.

Information necessary for the antenna to radiate a predetermined radio wave includes, for example, a radio wave output value, radio wave formation information, antenna calibration data, and the like. For example, the common function unit 21 has a function of acquiring various information described above from each master station device by means of a common protocol such as NETCONF (Network Configuration Protocol). The common function unit 21 has a function of controlling hardware such as an antenna by using a common protocol such as HDLC (Height-Level Data Link Control).

In order for the master station side shared slave station 10 to acquire the hardware control information from each master station device, the network configuration is different for each MNO to which each master station device belongs, so that the master station side shared slave station 10 needs to operate while absorbing the difference in the network configuration. The difference in the network configuration here means, for example, a difference among a MAC address, a VLAN ID, a network protocol, and an encryption protocol, a difference in physical connection systems between the slave station system 2 and the master station devices. Each individual function unit mounted on the master station side shared slave station 10 has a role of absorbing the difference in the network configuration described above. More specifically, for example, storage media such as memories in which connection information on connection with the master station devices and programs corresponding to the master station devices are stored, correspond to the individual function units. For example, physical interfaces for connecting to the master station devices also belong to the individual function units.

As described above, the slave station system 2 according to the present embodiment includes the master station side shared slave station 10 connected to the plurality of master station devices including at least the first master station device 3a and the second master station device 3b different from the first master station device 3a, and the slave station side shared slave station 20 connected to the master station side shared slave station 10. The master station side shared slave station 10 is equipped with the first individual function unit 11a corresponding to the first master station device 3a, and the second individual function unit 11b corresponding to the second master station device 3b. The slave station side shared slave station 20 is equipped with the common function unit 21 connected to the first individual function unit 11a and the second individual function unit 11b and functioning regardless of the types of the plurality of master station devices. According to the slave station system 2 constructed as described above, the equipment configuration can be simplified by two devices, i.e., the master station side shared slave station 10 and the slave station side shared slave station 20.

The master station side shared slave station 10 is installed in, for example, a collocation building or the like. The slave station side shared slave station 20 can be installed in a relatively narrow space such as under an antenna. The slave station side shared slave station 20 can also be installed in a narrow space such as a smart pole installation place or can be mounted on a smart pole.

Further, according to the present embodiment, for example, the functions of three or more slave station devices as in the conventional example shown in FIG. 2 can be implemented by two devices, namely, the master station side shared slave station 10 and the slave station side shared slave station 20.

For example, in order to simplify the equipment configuration, it is conceivable that a plurality of slave station devices in the conventional example shown in FIG. 2 are collectively accommodated in one housing. However, if a plurality of slave station devices installed at the same site are to be accommodated collectively in a single housing, it is impossible to avoid an increase in the size of the devices in consideration of the board configuration, the power supply configuration, the heat dissipation capability, and the like. If a plurality of slave station devices are to be accommodated in a single housing, it is impossible to sufficiently obtain the effect of improving the efficiency of the installation area. On the other hand, according to the configuration in which the master station side shared slave station 10 and the slave station side shared slave station 20 are separated as in the present embodiment, the effect of improving the efficiency of the installation area can be sufficiently obtained.

As shown in FIG. 1, the communication system 1 may include a shared antenna 30 that functions independently of the types of the master station devices. The slave station side shared slave station 20 may be connected to the shared antenna 30. Since the slave station system 2 according to the present embodiment includes the common function unit 21 having a common function independent of the individual settings of the master station devices, the same shared antenna 30 can be used for the plurality of master station devices. According to the present embodiment, for example, the infrastructure of a steel tower can be shared by the MNOs as the shared antenna 30. For example, a plurality of antennas required in the conventional example shown in FIG. 2 can be combined into one shared antenna 30.

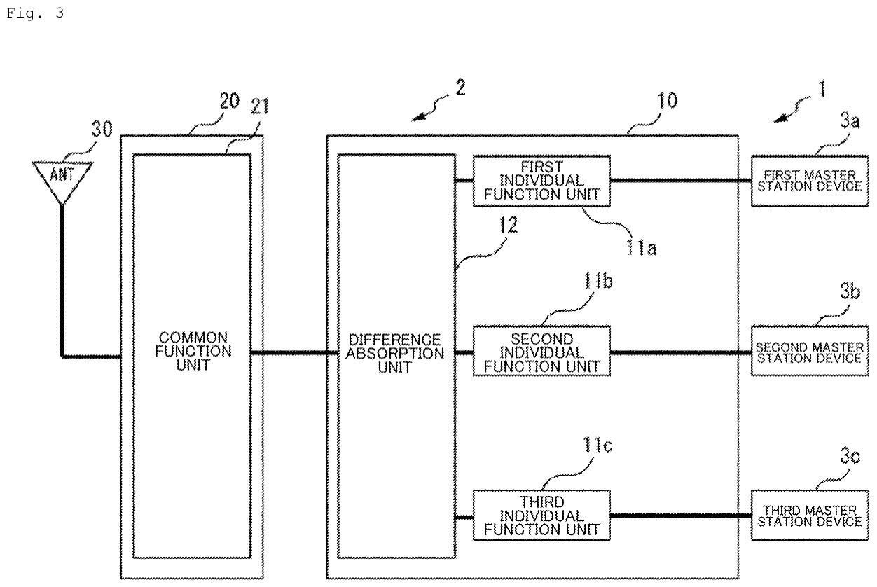

FIG. 3 is a diagram showing a modification of the communication system 1 according to Embodiment 1. In this modification, the master station side shared slave station 10 is equipped with a difference absorption unit 12. The difference absorption unit 12 is installed between the common function unit 21 and each individual function unit. In this modification, the common function unit 21 is connected to the first individual function unit 11a, the second individual function unit 11b, and the third individual function unit 11c via the difference absorption unit 12.

The difference absorption unit 12 is configured to absorb the difference among a signal transmitted between the first individual function unit 11a and the common function unit 21, a signal transmitted between the second individual function unit 11b and the common function unit 21, a signal transmitted between the third individual function unit 11c and the common function unit 21. The difference absorption unit 12 absorbs the duplication and difference of setting for each master station device, and enables transmission of a signal by a common protocol between the master station side shared slave station 10 and the slave station side shared slave station 20. The difference absorption unit 12 includes at least one of a demultiplexing function, a clock function, and a proxy function for the signals transmitted between each individual function unit and the common function unit 21. For example, when the communication system 1 is applied to a mobile base station, the difference absorption unit 12 performs demultiplexing on a C-plane signal and a U-plane signal. The difference absorption unit 12 further includes, as the clock function, for example, a Boundary Clock function for an S-plane signal, a Transparent Clock function, or a Master Clock function. The difference absorption unit 12 includes, for example, a network protocol conversion function for an M-plane signal, a NETCONF proxy function, an SSH relay function, and the like.

According to this modification, transmission media connecting the master station side shared slave station 10 and the slave station side shared slave station 20 can be integrated. For example, as shown in FIG. 3, the physical media connected to the master station side shared slave station 10 and the slave station side shared slave station 20 can be integrated into one. As shown in FIG. 3, the number of physical media connected to the master station side shared slave station 10 and the slave station side shared slave station 20 may be, for example, two. That is, three physical media required in the embodiment shown in FIG. 1 may be integrated into two. According to this modification, the equipment configuration can be further simplified.

Various functions of each individual function unit mounted on the master station side shared slave station 10 and the common function unit mounted on the slave station side shared slave station may be implemented by using dedicated hardware or by combining dedicated hardware and software. Various functions of the individual function units mounted on the master station side shared slave station 10 and the common function unit 21 mounted on the slave station side shared slave station 20 are specifically implemented by a controller or the like that performs information processing. Typically, the controller includes a processor and a memory. The memory includes, for example, a volatile memory or a nonvolatile memory. The various functions described above are implemented by the processor executing a control program stored in the memory. The control program may be recorded in a computer-readable recording medium. The controller may be realized with use of hardware such as an ASIC (Application Specific Integrated Circuit), a PLD (Programmable Logic Device), or an FPGA (Field Programmable Gate Array).

### Embodiment 2.

Next, Embodiment 2 will be described. Descriptions of the same components as those in Embodiment 1 are simplified and omitted. The following description will focus on differences with Embodiment 1.

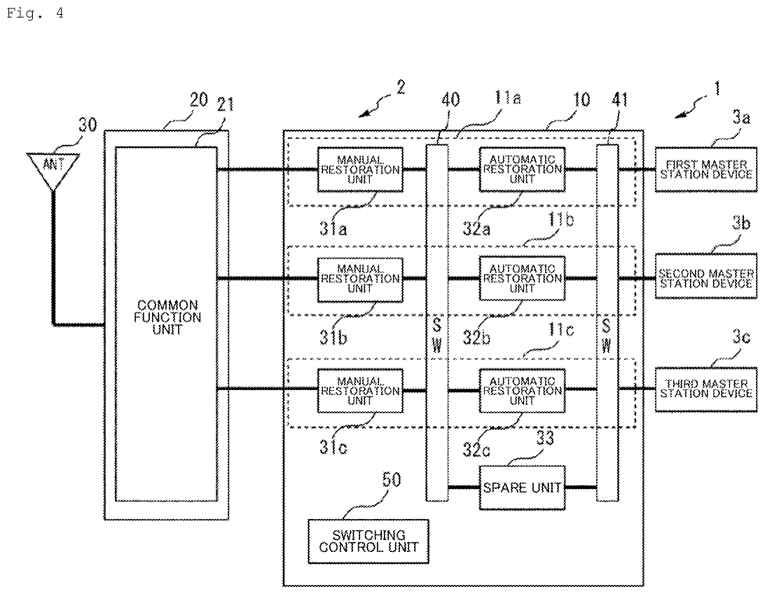

FIG. 4 is a diagram schematically showing an entire configuration of a communication system 1 according to Embodiment 2. As in Embodiment 1, the communication system 1 includes a plurality of master station devices and a slave station system 2 connected to the plurality of master station devices. The slave station system 2 includes the master station side shared slave station 10 and the slave station side shared slave station 20.

In this modification, individual function units mounted on the master station side shared slave station 10 are configured to be operable independently of each other. Even if an abnormality related to one of the plurality of individual function units occurs, the abnormality does not impact the other individual function units. For example, even if the first individual function unit 11a fails, the failure does not impact communication performed by the second master station device 3b and the third master station device 3c.

In this embodiment, the first individual function unit 11a includes a restoration function operated at least either manually or automatically. A restoration operation performed by the first individual function unit 11a does not impact the second individual function unit 11b and the third individual function unit 11c. A restoration operation performed by the first individual function unit 11a does not impact communication performed by the second master station device 3b and the third master station device 3c. Similarly to the first individual function unit 11a, it is more preferred that the second individual function unit 11b also include a restoration function. Similarly, it is more preferred that the third individual function unit 11c also include a restoration function. The common function unit 21 may also include a restoration function.

A specific example of the configuration of the individual function units having a restoration function is described with reference to FIG. 4. The first individual function unit 11a includes, for example, a manual restoration unit 31a and an automatic restoration unit 32a. The second individual function unit 11b includes, for example, a manual restoration unit 31b and an automatic restoration unit 32b. The third individual function unit 11c includes, for example, a manual restoration unit 31c and an automatic restoration unit 32c.

The master station side shared slave station 10 includes a spare unit 33. The spare unit 33 functions as a spare of the automatic restoration unit 32a. The spare unit 33 may function as a spare of the automatic restoration unit 32b and the automatic restoration unit 32c. That is, the spare unit 33 may be shared by the individual function units. A component or a function different from the spare unit 33 may be mounted as a spare of the automatic restoration unit 32b and the automatic restoration unit 32c.

In the present embodiment, the master station side shared slave station 10 includes a switch unit 40 provided between the automatic restoration unit and the manual restoration unit, and a switch unit 41 provided between the master station device and the automatic restoration unit. The master station side shared slave station 10 also includes a switching control unit 50. The switching control unit 50 controls, for example, each of the automatic restoration units, the switch unit 40, the switch unit 41, and the like. Although not shown in the diagrams, the switching control unit 50 is connected to each unit to be controlled, such as each automatic restoration unit, the switch unit 40, the switch unit 41, and the like. The switch unit 40, the switch unit 41, and the switching control unit 50 may be provided outside the master station side shared slave station 10.

For example, when the automatic restoration unit 32a fails, the switching control unit 50 causes the automatic restoration unit 32a to execute a switching operation of switching the function to the spare unit 33. For example, when the automatic restoration unit 32a fails, the switching control unit 50 causes the switch unit 40 to switch the connection between the automatic restoration unit 32a and the manual restoration unit 31a to the connection between the spare unit 33 and the manual restoration unit 31a. For example, when the automatic restoration unit 32a fails, the switching control unit 50 causes the switch unit 41 to switch the connection between the automatic restoration unit 32a and the first master station device 3a to the connection between the spare unit 33 and the first master station device 3a. Similarly, the switching control unit 50 performs various types of control even when the automatic restoration unit 32b or the automatic restoration unit 32c fails. Each automatic restoration unit notifies the switching control unit 50 of the operation status. The switching control unit 50 performs various types of control described above in accordance with the contents of the operation status notification from each automatic restoration unit. The switching control unit 50 may include a function of issuing an alert when a failure occurs in each automatic restoration unit. The switching control unit 50 may also include a function of issuing an alert when a failure occurs in the switch unit 40 and the switch unit 41.

As described above, the automatic restoration units are each a part capable of performing an automatic restoration operation. For example, a specific area of a storage medium such as a memory in which connection information on connection with the master station devices and a program are stored, corresponds to the automatic restoration units. For example, the automatic restoration units each have a function of developing the area into a spare area when a failure occurs in the area. The spare unit 33 corresponds to this spare area.

The manual restoration units are each a part corresponding to manual restoration such as component replacement. For example, a component such as a physical interface for connecting the master station side shared slave station 10 and the slave station side shared slave station 20, which requires replacement by site dispatch at the time of a failure, corresponds to a manual restoration unit. For example, replacing the manual restoration unit 31a does not impact the second individual function unit 11b and the third individual function unit 11c.

The switching control unit 50 may be connected to the manual restoration units. Similarly to the automatic restoration units, the manual restoration units may each have a function of notifying the switching control unit 50 of an operation status. The switching control unit 50 may each have a function of issuing an alert when a failure occurs in each manual restoration unit.

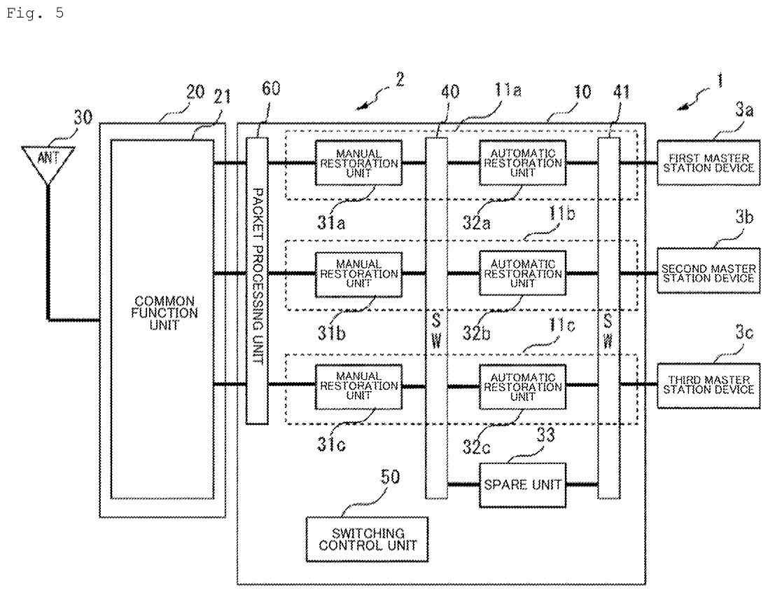

FIG. 5 is a diagram showing a modification of the communication system 1 according to Embodiment 2. In the present modification, the slave station system 2 includes a packet processing unit 60. The packet processing unit 60 is mounted on the master station side shared slave station 10 in the illustrated example, but the packet processing unit 60 can be installed at any location. For example, the packet processing unit 60 may be mounted on the slave station side shared slave station 20. The packet processing unit 60 can be installed at any position between the master station device and the common function unit 21. Further, the packet processing unit 60 may be composed of devices installed at a plurality of locations.

The packet processing unit 60 functions as an abnormal signal inflow prevention unit for preventing abnormal signal inflow from the master station device to the common function unit. Although not shown, in the present modification, the switching control unit 50 is connected to the packet processing unit 60. For example, the switching control unit 50 monitors an inflow state of traffic to the packet processing unit 60. The switching control unit 50 issues an alert when detecting inflow of an abnormal packet or inflow of excessive traffic from the master station device. When the switching control unit 50 detects inflow of an abnormal packet or inflow of excessive traffic from the master station device, the switching control unit 50 discards the packet that has flowed into the packet processing unit 60. According to the present modification, preventing abnormal signal inflow to the common function unit 21 can prevent a failure of the common function unit 21. The switching control unit 50 may include a function of issuing an alert when a failure occurs in the packet processing unit 60.

It should be noted that the foregoing embodiments and modifications thereof can be arbitrarily combined. For example, the difference absorption unit 12 shown in the modification of Embodiment 1 may be applied to Embodiment 2 and the modification thereof. The packet processing unit 60 shown in the modification of Embodiment 2 may be applied to Embodiment 1 and the modification thereof.

### Industrial Applicability

The slave station system according to the present disclosure can be applied to, for example, a mobile base station that provides wireless communication.

### REFERENCE SIGNS LIST

1 Communication system
2 Slave station system
2a First slave station device
2b Second slave station device
2c Third slave station device
3a First master station device
3b Second master station device
3c Third master station device
10 Master station side shared slave station
11a First individual function unit
11b Second individual function unit
11c Third individual function unit
12 Difference absorption unit
20 Slave station side shared slave station
21 Common function unit
30 Shared antenna
31a Manual restoration unit
31b Manual restoration unit
31c Manual restoration unit
32a Automatic restoration unit
32b Automatic restoration unit
32c Automatic restoration unit
33 Spare unit
40 Switch unit
41 Switch unit
50 Switching control unit
60 Packet processing unit

1. A slave station system, comprising: a first shared slave station device that is connected to a plurality of master station devices including at least a first master station device and a second master station device different from the first master station device; and a second shared slave station device that is connected to the first shared slave station device, wherein the first shared slave station device is equipped with a first individual function unit connected to the first master station device and corresponding to the first master station device, and a second individual function unit connected to the second master station device and corresponding to the second master station device, and the second shared slave station device is equipped with a common function unit connected to the first individual function unit and the second individual function unit and functioning regardless of the types of the plurality of master station devices.

2. The slave station system according to claim 1, wherein the plurality of master station devices include a third master station device different from the first master station device and the second master station device, the first shared slave station device is equipped with a third individual function unit corresponding to the third master station device, and the common function unit is connected to the third individual function unit.

3. The slave station system according to claim 1, wherein the second shared slave station device is connected to a shared antenna that functions regardless of the types of the plurality of master station devices.

4. The slave station system according to claim 1, wherein the first shared slave station device is equipped with a difference absorption unit for absorbing a difference between a signal transmitted between the first individual function unit and the common function unit and a signal transmitted between the second individual function unit and the common function unit, and the common function unit is connected to the first individual function unit and the second individual function unit via the difference absorption unit.

5. The slave station system according to claim 1, wherein the first individual function unit and the second individual function unit are configured to be operable independently of each other, and the first individual function unit includes a restoration function operated at least either manually or automatically.

6. The slave station system according to claim 5, wherein the second individual function unit includes a restoration function operated at least either manually or automatically.

7. The slave station system according to claim 1, further comprising an abnormal signal inflow prevention unit that is located between the plurality of master station devices and the common function unit and prevents abnormal signal inflow to the common function unit.
